(19) United States
(12) Patent Application Publication
(10) Pub. No.: US 2006/0218290 A1
(43) Pub. Date: Sep. 28, 2006

(54) System and method of request scheduling for differentiated quality of service at an intermediary

(76) Inventors: Ying-Dar Lin, Hsinchu (TW); Shuo-Yen Wen, Hsinchu (TW); Ching-Ming Tien, Hsinchu (TW); Yuan-Cheng Lai, Hsinchu (TW); Tzuo-Chun Lee, Hsinchu (TW); Po-Wen Cheng, Hsinchu (TW)

Correspondence Address: HARNESS, DICKEY & PIERCE, P.L.C., P.O. BOX 8910, RESTON, VA, 20195, US

(21) Appl. No.: 11/222,770

(22) Filed: Sep. 12, 2005

(30) Foreign Application Priority Data
Mar. 23, 2005 (TW) 94109018

(51) Int. Cl. G06F 15/16

(52) U.S. Cl. 709/229

(57) ABSTRACT

A system and a method of request scheduling for differentiated quality of services at an intermediary are provided. An intermediary located between clients and a server is used to schedule requests from the clients in the Internet. The intermediary classifies the requests and decides resources required for each request according to the administrative policies. Then the intermediary decides the order and the time the requests being transferred to the server by the size of the responses corresponding to the requests, window control and server loading. Therefore, the system is transparent to clients and servers and is capable of high compatibility with other systems.

### FIELD OF THE INVENTION

The invention generally relates to a system and method of request scheduling applied in Internet services, and in particular relates to a system and method of request scheduling at an intermediary of a network according to the kind of request, size of response and window control.

### BACKGROUND OF THE INVENTION

In accompany with the blooming developments of Internet services, the server applications are getting more and more. The loads of servers also become heavier and heavier as the Internet population becoming larger and larger.

However, the heavy load of the application server lengthens the waiting time at the client ends, or even ties up the whole service of the application server. Therefore, many application servers try to differentiate their service levels and provide higher throughputs to those higher-class users. That means to shorten the waiting time of the higher-class users by giving higher priorities of response so as to provide better services and to gain higher satisfactory of the users.

The conventional differentiated services are approached by modifications of operation systems of the servers or additional scheduling programs for the services. However, the modified application systems or additional programs use the resources of the application servers. They are dependent to the conditions of the application servers and are easy to decrease the stabilities and performances of the servers.

A prior art, as disclosed in U.S. Pat. No. 6,742,016, is to provide an acceptor for admitting incoming requests to a server application system. It includes a session manager that determines the class of an incoming request. The classes include the first class and the second class. A queuing module is provided to store the request if the incoming request is of the second class. A priority control module is provided to ensure that a predetermined number of requests are sent to the server application for service in each round. The priority control module allows (1) the predetermined number of the first class requests to be sent to the server application if the first class requests received in a round are at least equal to the predetermined number, and (2) a mixture of the first class requests and the second class requests to be sent to the server application if the first class requests received in a round are less than the predetermined number. Though the numbers of requests to be processed are according to the differentiated classes, they are not relative to the service quality because each request expends different amount of resources of the application server. Processing more first-class requests does not necessarily give more services than processing less second-class requests. Therefore, the first class user may not get better services or spend less waiting time from it.

U.S. Pat. No. 6,728,748 discloses an apparatus in which a routing host is configured to receive all client requests for sites and virtual sites implemented on a plurality of servers. A monitoring processor incorporating an Adaptive Policy Engine, in communication with the router and agents installed on back-end servers, dynamically monitors workload and availability of servers to enable requests to be sent to the most appropriate and optimal server. Incoming traffic is first processed to assign a class based on user-defined policies. The apparatus utilizes the server cluster method to achieve the differentiated services. However, it requires server modifications and much expense on the server installations.

In order to improve the service quality, to lessen the influence to the application server for differentiated services and to improve the compatibility of server application, it is desired to have an application server for the Internet that can truly implement differentiated services.

### SUMMARY OF THE INVENTION

The object of the invention is to provide a system and method of request scheduling applied in Internet services. The request scheduling is implemented at an intermediary between user ends and the application server so that differentiated services are provided as usual without changes at the user ends or at the application server.

The most important part of a differentiated service is the request classification. The invention not only classifies requests according to the network-layer information (source address, destination address, port number and protocol) but also the application-layer information (the header and payload) of the request. This process widens the applications of differentiated service.

The invention further provides weighting means for differentiating the server resources of different application servers. Therefore, the service sequence of responding to external requests is decided by the service quanta and the size of responses. Further, the service quanta make the higher-grade users sharing more server resources and waiting less time than the lower-grade users so as to get higher service qualities.

To prevent the application server from overload of massive external requests, the invention further provides window control to determine the transferring time of scheduled requests. All the classified requests are queued and wait for being sent. This helps the application server working in the best condition and stabilizes the whole scheduling operation.

A system of request scheduling for differentiated quality of service at an intermediary according to the invention includes: a prober for checking the request items and the correspondent size of responses; a request/response list for recording the aforesaid request items and size of responses; a classifier for classifying the external requests from clients; a service quality policy list for storing classification items; class queues for storing the classified requests according to the service quality policy list; and a scheduler for scheduling the queued requests to the application server in a scheduler manner according to the size of responses.

A method of request scheduling for differentiated quality of service at an intermediary according to the invention includes steps of: checking the request items and the correspondent size of responses; recording the request items and size of responses in a request/response list; establishing a service quality policy list; receiving and classifying external requests from clients; queuing the classified requests to the class queues according to the service quality policy list; setting the service quanta, scheduler pointer, and the window size; and scheduling the queued requests to the application server in a scheduler manner according to the size of responses.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is a schematic diagram of the invention of a system of request scheduling for differentiated quality of service at an intermediary;

FIG. 1B shows an explanatory source code of a service quality policy list in the invention of a system of request scheduling for differentiated quality of service at an intermediary;

FIG. 1C is an explanatory diagram of initial state of class queues and a scheduler in the invention of a system of request scheduling for differentiated quality of service at an intermediary;

FIG. 1D is an explanatory diagram of request processing and the window size in the invention of a system of request scheduling for differentiated quality of service at an intermediary;

FIG. 2A is a flowchart of the invention of a method of request scheduling for differentiated quality of service at an intermediary; and

FIGS. 2B and 2C are detailed flowcharts of the invention of a method of request scheduling for differentiated quality of service at an intermediary.

### DETAILED DESCRIPTION OF THE INVENTION

The invention provides a system and a method applied in the Internet for scheduling the requests at an intermediary and providing differentiated services to an application server. The so-called intermediary is a network node, such as a gateway, a router, a proxy server or a server load balancer, located between an application server and at least a client. All the requests from the clients pass through the intermediary to the application server. Then, the server provides corresponding services and responses.

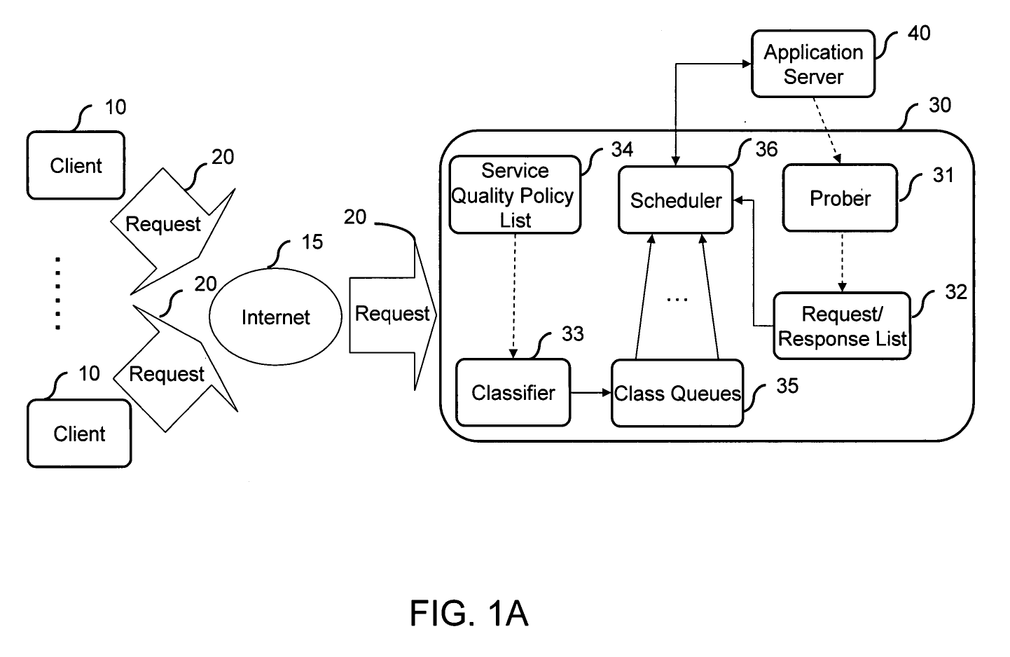

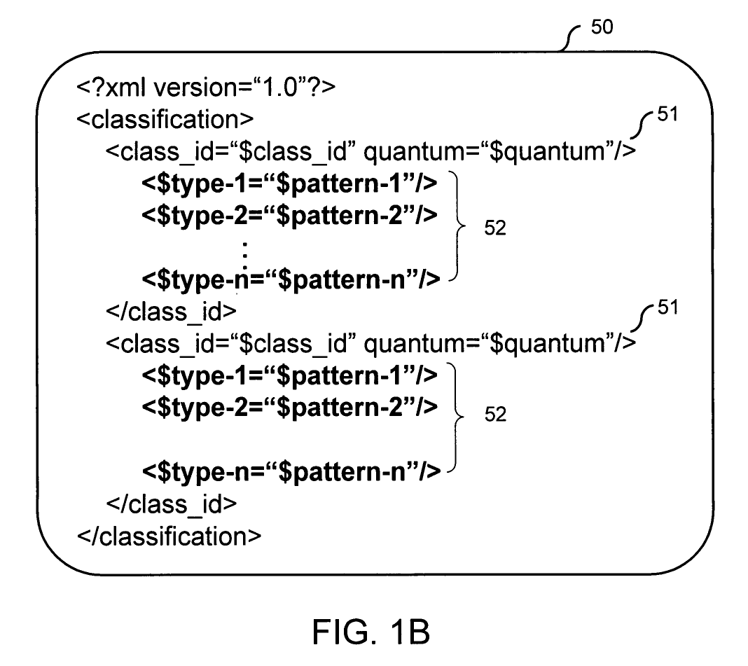

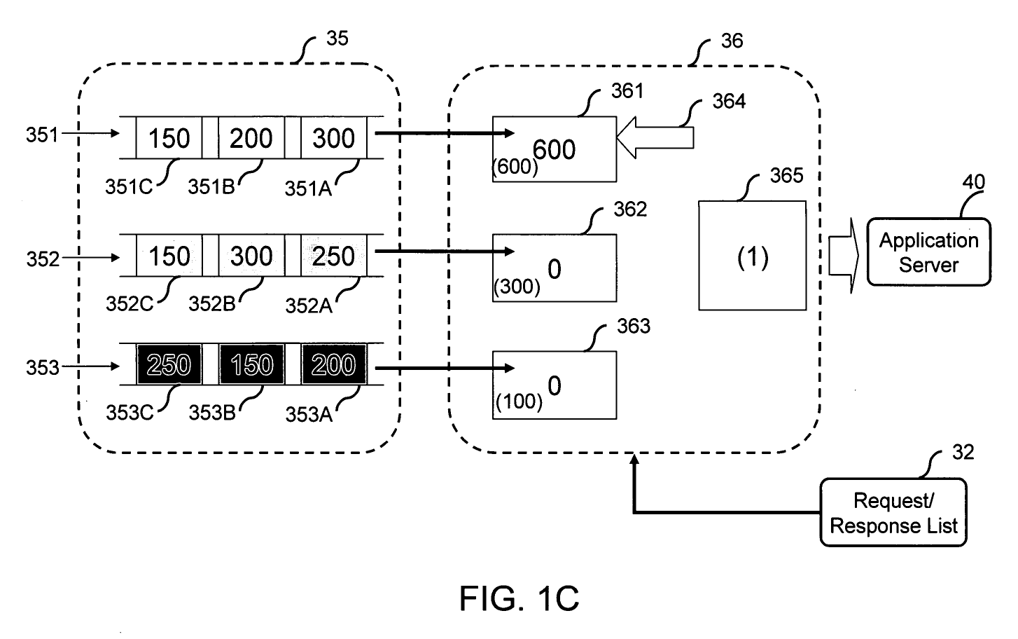

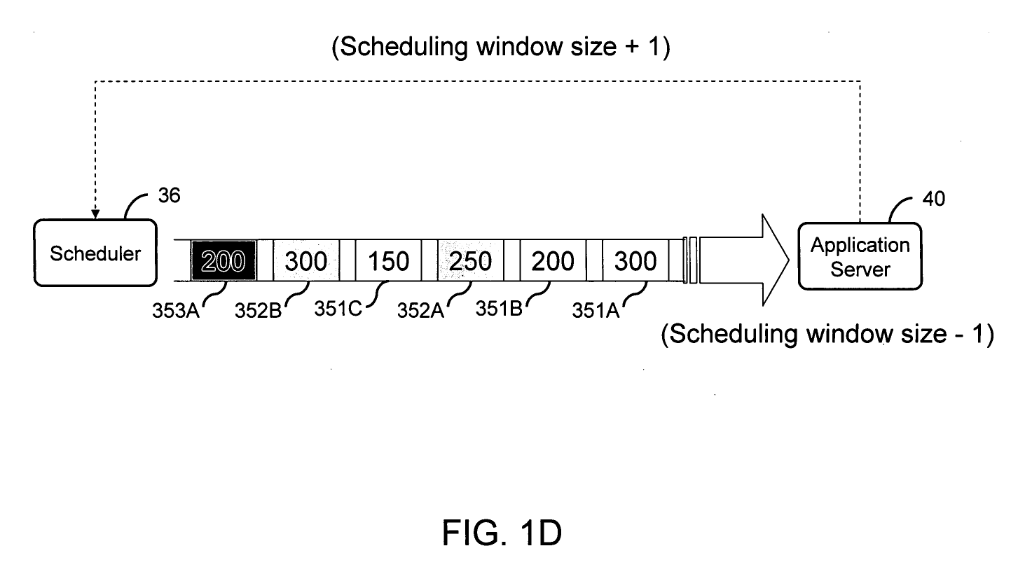

As shown in FIG. 1A, a system 30 of request scheduling for differentiated quality of service at an intermediary according to the invention includes: a prober 31 for checking the requests 20 to the application server 40 and the correspondent size of responses; a request/respond list 32 for recording the aforesaid requests and size of responses; a classifier 33 for classifying the external requests from clients; a service quality policy list 34 for storing classification items 51; class queues 35 for storing the classified requests according to the classification items 51 in the service quality policy list 34; and a scheduler 36 for scheduling the queued requests 20 in a round-robin manner to the application server 40 according to the size of responses.

FIG. 1B shows an explanatory source code 50 of a service quality policy list 34 in the invention. The source code 50 includes at least a classification item 51 for classifying the external requests. The classification rules include network-layer information, such as source address, destination address, port number, protocol and so on; and also application-layer information of the external request, such as the header and payload. Though the exemplary source code in FIG. 1B is of Extensible Markup Language (XML), other programming languages are not limited to the application.

FIG. 1C is an explanatory diagram of initial state of class queues 35 and a scheduler 36 in the invention. The class queues 35 include at least a queue corresponding to the classification item 51 in the service quality policy list 34. As shown in FIG. 1C, the service quality policy list 34 is composed of three classification items 51. Therefore there are three class queues 35, i.e., first queue 351, second queue 352 and third queue 353, for storing classified different requests 20.

In the initial state, the scheduler 36 includes deficit counters, each of which correspond to a class queue 35, i.e., first deficit counter 361, second deficit counter 362 and third deficit counter 363. Each deficit counter is set with a service quantum. For example, a service quantum“600” for the first deficit counter 361, a service quantum“300” for the second deficit counter 361, and a service quantum“100” for the third deficit counter 361. The service quanta are used to control the service resource ratios of the application server 40 provided to the requests 20. The service quanta can be arranged according to different requirements. The scheduler 36 also includes a round-robin pointer 364 and a scheduling window size 365. The round-robin scheduler pointer 364 points cyclically among the class queues 35 according to the Deficit Round Robin scheduling. When pointing to a queue, it compares the response size of the queued requests 20 (obtained from the request/respond list 32) in the queue with the value of the corresponding deficit counter, and decides whether or not to transfer the request 20. The scheduling window size 365 is used to control the number of concurrent requests 20 to be transferred at a time to the application server 40. The window size 365 is set according to the processing capacity of the application server 40.

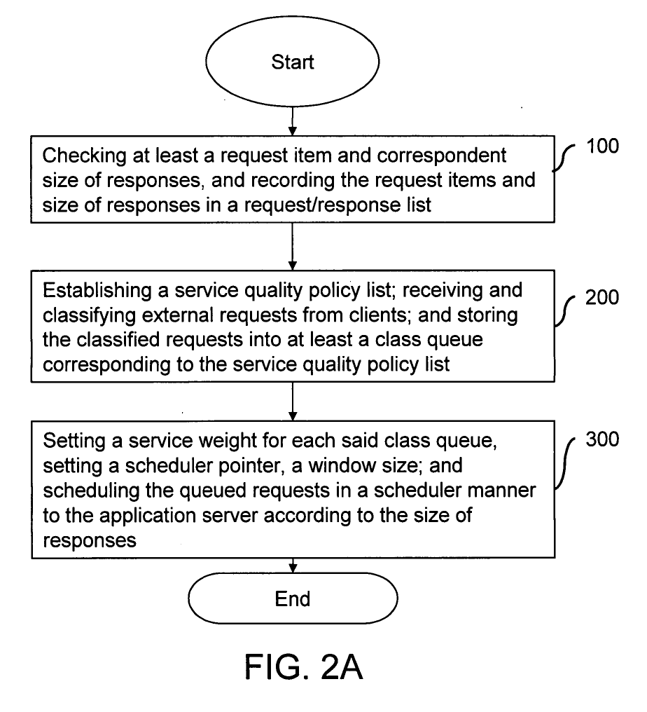

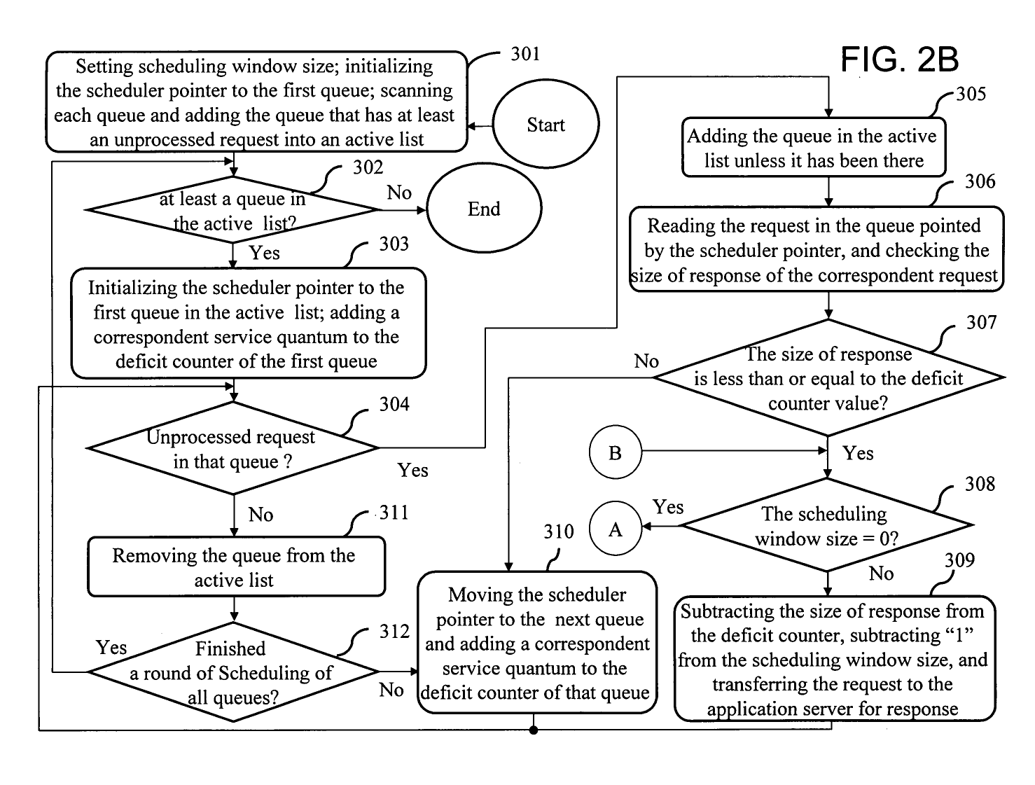

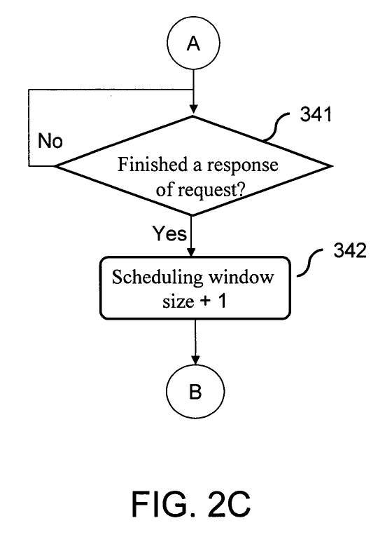

FIG. 2A is a flowchart of the invention of a method of request scheduling. First, checking (by a prober 31) the request items and the correspondent size of responses (the bytes of response required for the application server 40 to transfer when responding the request 20) and recording in a request/response list (step 100). The checking is done hierarchically by first checking the first level of requests, then checking the second level of requests liked by the requests in the first level, and so on, till the last level to finalize the size counting. Then, based on a preset service quality policy list, receiving and classifying (by a classifier 33) external requests 20 from clients 10; and storing the classified requests 20 into corresponding queues (step 200). The service quality policy list 34 is composed of a plurality of classification items 51 for classifying the requests 20. The number of class queues 35 is correspondent to the classification items 51. Then, in the scheduler 36, setting a round-robin scheduler pointer 364 and a scheduling window size 365, and setting each deficit counter a service quantum for the queued requests. Finally, schedule the queued requests 20 in a round-robin manner to the application server 40 according to the size of responses (step 300).

The detailed process of step 300 is shown in FIG. 2B. First, setting the scheduling window size 365; then moving the round-robin scheduler pointer 364 to the first queue; scanning each queue and adding the queue that has at least an unprocessed request into an active list (step 301). The scheduler 36 only processes the queues listed in the active list. Then, checking if there is at least a queue in the active list (step 302); if not, that means there is no more request, then the scheduler 36 stops scheduling and ends the whole process (step 300).

If there is at least a queue in the active list, then moving the round-robin scheduler pointer 364 to the first queue in the active list; incrementing a correspondent service quantum to the deficit counter of the first queue (step 303); checking if there is unprocessed request 20 in that queue (step 304); if yes, adding the queue in the active list unless it has been there (step 305); further reading the request 20 in the queue pointed by the round-robin scheduler pointer 364, and checking the size of response of the correspondent request 20 according to the request/response list 32 (step 306). When the size of response is less than or equal to the deficit counter value (step 307) and the scheduling window size is non-zero (step 308), then decrementing the size of response from the deficit counter, decrementing “1” from the scheduling window size 365, and transferring the request 20 to the application server 40 for response (step 309).

When there is still unprocessed request 20 in the pointed queue (step 304), repeating the steps (305, 306, 307, 308 and 309) of reading and processing requests in that queue. When finishing all the requests in the pointed queue (step 304), removing the queue from the active list (step 311); checking if the scheduler 36 has finished a round of scheduling of all queues (step 312); if yes, returning to step 302; if not, pointing the round-robin scheduler pointer to the next queue; incrementing a correspondent service quantum to the deficit counter of the pointed queue (step 310), and continuing with step 304. Besides, when the size of response is larger than the deficit counter value (step 307), moving the round-robin scheduler pointer to the next queue and incrementing a correspondent service quantum to the deficit counter of that queue (step 310).

The aforesaid scheduling window size 365 is used to control the number of concurrent requests 20 that can be transferred to the application server 40 for processing at a time. Therefore, each time when transferring a request 20 (step 309), the scheduling window size 365 is decremented with “1”. When the scheduling window size 365 becomes zero, all the external requests are temporarily retained in the queue and waiting for process of the application server 40. As illustrated in FIG. 2C, from node A, the scheduling system 30 will wait for the application server 40 to finish processing a response of request (step 341). When the application server 40 has processing a request 20, it responses to the scheduling system 30. Then, the scheduling window size 365 is incremented with “1” (step 342), the application server 40 can further process other requests. Therefore, from node B, the process returns to step 308 of FIG. 2B and continues.

Further refer to FIGS. 1C and 1D for detailed description of embodiments. As shown in FIG. 1C, there are three class queues 35 in the active list, i.e., first queue 351, second queue 352 and third queue 353, for storing classified requests 20. For example, the first queue 351 contains requests 351A, 351B and 351C having response size (checked from a request/response list 32) of “300”, “200” and “150” respectively; the second queue 352 contains requests 352A, 352B and 352C having response size of “250”, “300” and “150” respectively; and the third queue 353 contains requests 353A, 353B and 353C having response size of “200”, “150” and “250” respectively. In the scheduler 36, there are deficit counters correspondent to class queues 35, that are first deficit counter 361 (set with service quantum “600”), second deficit counter 362 (set with service quantum “300”) and third deficit counter 363 (set with service quantum “100”). The scheduler 36 further includes a round-robin pointer 364 (initially pointing to the deficit counter 361 of first queue 351) and a scheduling window size 365 (initially set with “1”).

When starting the scheduling, the round-robin scheduler pointer 364 is first pointed to the first deficit counter 361 of the first queue 351, the first deficit counter 361 is incremented with service quantum “600”, and the process of request 20 of the first queue 351 starts. First, reading the first request 351A in the first queue 351. Because the size “300” of the first request 351A is less than the counter value “600” of the first deficit counter 361, and the scheduling window size 365 is non-zero, so the scheduler 36 transfers the request 20 to the application server 40 for response. Then, the counter value “600” of the first deficit counter 361 is decremented with “300” and becomes “300”; the scheduling window size “1” is decremented with “1” and becomes “0”. Further, reading the second request 351B in the first queue 351. Though the size “200” of the request 351B is less than the value “300” of the first deficit counter 361, but the scheduling window size 365 is zero, therefore, no further request is transferred to the application server 40 till the scheduling window size 365 changes to non-zero.

When the application server 40 receives the first request 351A of the first queue 351, it processes the first request 351A and transfers a response to the scheduler 36. The scheduler 36 forwards the response to the client 10 via the Internet 15. The scheduling window size 365 is then incremented with “1” and changed from “0” to “1”. As the scheduling window size 365 is non-zero, the scheduler 36 starts to transfer the second queue 351B. The counter value “300” of the first deficit counter 361 is decremented with the size “200” of the second response 351B and becomes “100”. Meanwhile, the scheduling window size is decremented with “1” and becomes “0”. Further reads the third queue 351C. Since the response size “150” of the third request 351C is larger than the first deficit counter value “100”, the round-robin scheduler pointer 364 is moved to the second queue 352, and the second deficit counter 362 is incremented with a correspondent service quantum “300”.

The scheduler 36 starts reading the first request 352A in the second queue 352. Though the size “250” of the first request 352A is less than the counter value “300” of the second deficit counter 362, the scheduling window size is still “0”, the first request 352A in the second queue 352 cannot be transferred till the application server 40 finishing response of the prior request (i.e., the second request 351B in the first queue 351) to the client 10 via the Internet 15 After the application server 40 has finished transferring the response of the second request 351B to the client 10 via the Internet 15, the scheduling window size 365 is incremented with “1” and the transferring of the first request 351A in the second queue 353 is proceeded.

The same process continues. When the round-robin scheduler pointer 364 stays at the third queue 353 and intends to move the next queue, a round is finished now. Then, the round-robin scheduler pointer 364 is re-initialized by Deficit Round Robin scheduling and set to first deficit counter 361 for further process. The value “100” of the first deficit counter 361 is then incremented with the service quantum “600” to become “700”. And, the process of the third request 351C in the first queue 351 continues.

When there is no unprocessed request 20 in a queue, the round-robin scheduler pointer 364 will be moved to the next queue. The process continues till all the requests 20 are finished. Please note that when a queue has no any request 20, it is then removed from the active list. When there is a new request 20 entering into an empty queue, the queue can be added again in the active list. The round-robin scheduler pointer only points to the queues in the active list; and the service quantum is only incremented to that queue. The queue removed from the active list will not be scheduled, and the deficit counter will not be incremented with a corresponding service quantum.

FIG. 1D shows another explanatory view of the aforesaid embodiment. In the process of the scheduling system 30, each time when the scheduler 36 transfers a request 20 to the application server 40, the scheduling window size 365 is decremented with “1”; and each time when the application server 40 finishes response of a request, the scheduling window size 365 is incremented with “1”.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of request scheduling applied in a network for differentiated quality of service at an intermediary between at least a client and an application server, comprising:
a prober for checking at least a request items to said application server and correspondent size of responses of said requests, and registering in a request/respond list;
a classifier for establishing a service quality policy list and classifying said requests received from said clients;
class queues for setting at least a queue corresponding to said service quality policy list and storing said classified requests into said queues; and
a scheduler for setting each said queue with a corresponding service quantum, setting a scheduler pointer and a scheduling window size, and transferring said queued requests to said application server in a scheduler manner according to size of responses to said requests.

2. The system of request scheduling applied in a network for differentiated quality of service at an intermediary according to claim 1 wherein said size of response is bytes of response required for said application server to transfer when responding said request.

3. The system of request scheduling applied in a network for differentiated quality of service at an intermediary according to claim 1 wherein said request classifying is based on network-layer information.

4. The system of request scheduling applied in a network for differentiated quality of service at an intermediary according to claim 1 wherein said request classifying is based on application-layer information.

5. The system of request scheduling applied in a network for differentiated quality of service at an intermediary according to claim 1 wherein said scheduler pointer moves circularly among said queues by Deficit Round Robin scheduling.

6. The system of request scheduling applied in a network for differentiated quality of service at an intermediary according to claim 1 wherein said scheduling window size is used to control the number of concurrent requests to be transferred at a time to said application server.

7. The system of request scheduling applied in a network for differentiated quality of service at an intermediary according to claim 1 wherein said scheduler further comprises at least a counter corresponding to said queues for accumulating said corresponding service quanta.

8. A method of request scheduling applied in a network for differentiated quality of service at an intermediary between at least a client and an application server, comprising steps of:
checking at least a request item and correspondent size of responses, and recording said request items and size of responses in a request/response list;
establishing a service quality policy list; receiving and classifying external requests from clients; and storing said classified requests into at least a queue corresponding to said service quality policy list; and
setting a service quantum for each said queue, setting a scheduler pointer, a window size; and transferring said queued requests to said application server in a scheduler manner according to said size of responses.

9. The method of request scheduling applied in a network for differentiated quality of service at an intermediary according to claim 8 wherein said size of response is bytes of response required for said application server to transfer when responding said request.

10. The method of request scheduling applied in a network for differentiated quality of service at an intermediary according to claim 8 wherein said request classifying is based on network-layer information.

11. The method of request scheduling applied in a network for differentiated quality of service at an intermediary according to claim 8 wherein said request classifying is based on application-layer information.

12. The method of request scheduling applied in a network for differentiated quality of service at an intermediary according to claim 8 wherein said scheduler pointer moves circularly among said queues by Deficit Round Robin scheduling.

13. The method of request scheduling applied in a network for differentiated quality of service at an intermediary according to claim 8 wherein said scheduling window size is used to control the number of concurrent requests to be transferred at a time to said application server.

14. The method of request scheduling applied in a network for differentiated quality of service at an intermediary according to claim 8 wherein said step of setting a service quantum for each said queue, setting a scheduler pointer, a window size; and scheduling said queued requests to said application server according to said size of responses further comprises steps of:
a) setting said scheduling window size; moving said scheduler pointer to the first queue; incrementing a correspondent service quantum to said deficit counter of said first queue;
b) reading said request in said queue, and checking the size of response of said correspondent request;
c) when said size of response is less than said deficit counter value and said scheduling window size is non-zero, decrementing said size of response from said deficit counter, decrementing 1 from said scheduling window size, and transferring said request to said application server for response, and
d) moving said scheduler pointer to next queue, and incrementing a correspondent service quantum to said deficit counter of said queue;
in step c), when there is still unprocessed request in said queue, or said size of response is not larger than that counter, repeating steps b) and c);
repeating steps b) to d) till finishing a round of scheduling of all queues; moving said scheduler pointer to the first queue; incrementing a correspondent service quantum to said deficit counter of said first queue; and restarting steps b) to d).

15. The method of request scheduling applied in a network for differentiated quality of service at an intermediary according to claim 14 wherein said step of setting a service quantum for each said queue, setting a scheduler pointer, a window size; and scheduling said queued requests to said application server in a scheduler manner according to said size of responses further comprises steps of incrementing said scheduling window size with “1” when receiving information of said application server that has finished a response of request.
